(19) United States
(12) Patent Application Publication
(10) Pub. No.: US 2013/0165222 A1
(43) Pub. Date: Jun. 27, 2013

(54) MEDIA MANAGEMENT SYSTEM FOR MANAGEMENT OF GAMES ACQUIRED FROM A MEDIA SERVER

(71) Applicant: Apple Inc., Cupertino, CA (US)

(72) Inventor: Christopher R. Wysocki, Los Gatos, CA (US)

(73) Assignee: APPLE INC., Cupertino, CA (US)

(21) Appl. No.: 13/689,520

(22) Filed: Nov. 29, 2012

Related U.S. Application Data
(63) Continuation of application No. 11/481,303, filed on Jul. 3, 2006, now abandoned.
(60) Provisional application No. 60/810,349, filed on Jun. 2, 2006.
(60) Provisional application No. 60/810,423, filed on Jun. 2, 2006.

(51) Int. Cl. A63F 13/12

(52) U.S. Cl. CPC A63F 13/12
USPC 463/29; 463/42

(57) ABSTRACT

A management application, or media management application, for managing game software is disclosed. In one embodiment, the media management application can also manage other types of media besides games, such other media can include music, videos, images, audiobooks, and/or podcasts.

This application is a continuation of, and hereby claims benefit of priority from, pending U.S. patent application Ser. No. 11/481,303, filed Jul. 3, 2006, and entitled “MANAGEMENT SYSTEM FOR MANAGEMENT OF GAMES ACQUIRED FROM A MEDIA SERVER,” which is hereby incorporated by reference. This application further claims benefit of priority from: (i) expired U.S. Provisional Patent Application No. 60/810,349, filed Jun. 2, 2006, and entitled “MEDIA MANAGEMENT SYSTEM FOR MANAGEMENT OF GAMES ACQUIRED FROM A MEDIA SERVER,” which is hereby incorporated herein by reference; and (ii) expired U.S. Provisional Patent Application No. 60/810,423, filed Jun. 2, 2006, and entitled “TECHNIQUES FOR INTERACTIVE INPUT TO PORTABLE ELECTRONIC DEVICES,” which is hereby incorporated herein by reference, both of which parent application Ser. No. 11/481,303 claims benefit of priority from.

This application is related to: (i) U.S. patent application Ser. No. 10/833,267, filed Apr. 26, 2004, and entitled “METHOD AND SYSTEM FOR NETWORK-BASED PURCHASE AND DISTRIBUTION OF MEDIA,” which is hereby incorporated herein by reference, (ii) U.S. patent application Ser. No. 10/118,069, filed Apr. 5, 2002, and entitled “INTELLIGENT SYNCHRONIZATION OF MEDIA PLAYER WITH HOST COMPUTER,” which is hereby incorporated herein by reference: (iii) U.S. patent application Ser. No. 10/277,418, filed Oct. 21, 2002, and entitled “INTELLIGENT INTERACTION BETWEEN MEDIA PLAY ER WITH HOST COMPUTER,” which is hereby incorporated herein by reference; (iv) U.S. patent application Ser. No. 10/832,984 filed Apr. 26, 2004, and entitled “GRAPHICAL USER INTERFACE FOR BROWSING, SEARCHING AND PRESENTING MEDIA ITEMS,” which is hereby incorporated herein by reference; (v) U.S. patent application Ser. No. 10/903,496, filed Jul. 30, 2004, and entitled “GRAPHICAL USER INTERFACE FOR BROWSING, SEARCHING AND PRESENTING CLASSICAL WORKS,” which is hereby incorporated herein by reference; and (vi) U.S. patent application Ser. No. 11/061,321, filed Feb. 17, 2005, and entitled “GRAPHICAL USER INTERFACE FOR BROWSING, SEARCHING AND PRESENTING MEDIA ITEMS,” which is hereby incorporated herein by reference.

### BACKGROUND OF THE INVENTION

1. Field of the Invention

The present invention relates to media purchase and distribution and, more particularly, to purchase and distribution of games in a client-server environment.

2. Description of the Related Art

Conventionally, music and videos can be purchased from an online media store, such as the iTunes Music Server® provided by Apple Computer, inc. Immediately following the purchase of a music or video from the on-line music store, it is available for electronic download by the purchaser. However, online media stores do not conventionally also support purchase and download of games for player devices (e.g., portable media devices). Games can be independently purchased and downloaded from various game related websites. Unfortunately, however, even if games can be purchased and downloaded, management of the games is conventionally not available. Additionally, installation of games on a player device can be cumbersome. Accordingly, there is a need to facilitate purchase, download, installation and management of games acquired electronically from an on-line media source for use on a player device.

### SUMMARY OF THE INVENTION

The invention pertains to a management application, or media management application, for managing game software. In one embodiment, the media management application can also manage other types of media besides games, such other media can include music, videos, images, audiobooks, and/or podcasts.

The invention can be implemented in numerous ways, including as a method, system, device, apparatus (including graphical user interface), or computer readable medium. Several embodiments of the invention are discussed below.

As a computer-implemented method for automatically updating a software game at a client device, the software game being previously acquired from a server device, one embodiment of the invention includes at least the acts of: determining hardware platform information that describes a hardware platform pertaining to a portable media device that is associated with and periodically connected to the client device; retrieving client version information from the client device for the software game with respect to the hardware platform information; retrieving server version information from the server device for the software game with respect to the hardware platform information; comparing the client version information with the server version information; determining whether a newer version of the software game for use with the hardware platform pertaining to the portable media device is available from the server device; and downloading the newer version of the software game to the client device when it is determined that the newer version of the software game for use with the hardware platform pertaining to the portable media device is available from the server device.

As a computer-implemented method for automatically updating a software game at a client device, the software game being previously acquired from a server device, another embodiment of the invention includes at least the acts of: obtaining compatibility information pertaining to a portable electronic device that is associated with and periodically connected to the client device; determining whether a newer version of the software game for use on the portable electronic device is available from the server device based on the compatibility information and on a previously downloaded version for the software game; and downloading a newer version of the software game from the server device to the client device when it is determined that the newer version of the software game for use with the portable electronic device is available from the server device.

As a computer readable medium including at least computer program code for automatically updating a software game at a client device, the software game being previously acquired from a server device, one embodiment of the invention includes at least: computer program code for obtaining compatibility information pertaining to a portable electronic device that is associated with and periodically connected to the client device; computer program code for determining whether a newer version of the software game for use on the portable electronic device is available from the server device based on the compatibility information and on a previously downloaded version for the software game; and computer program code for downloading a newer version of the software game from the server device to the client device when it is determined that the newer version of the software game for use with the portable electronic device is available from the server device.

As a computer-implemented method for downloading a software game from a server device to a client device, one embodiment of the invention includes at least the acts of: obtaining compatibility characteristics for a portable media device that is associated with and periodically connected to the client device; identifying a particular software game version available at the server device based on the compatibility characteristics for the portable media device; and downloading the particular software game version from the server device to the client device.

As a computer readable medium including at least computer program code for downloading a software game from a server device on a client device, one embodiment of the invention includes at least: computer program code for obtaining compatibility characteristics for a portable media device that is associated with and periodically connected to the client device; computer program code for identifying a particular software game version available at the server device based on the compatibility characteristics for the portable media device; and computer program code for downloading the particular software game version from the server device to the client device.

As a computer-implemented method for transferring game data from a portable electronic device where a software game is played to a client device, one embodiment of the invention includes at least the acts of: retrieving game play data from the portable electronic device, the software game having been previously operated on the portable electronic device to produce game play data; and storing the game play data at the client device.

As a computer readable medium including at least computer program code for transferring game data from a portable electronic device where a software game is played to a client device, one embodiment of the invention includes at least: computer program code for retrieving game play data from the portable electronic device, the software game having been previously operated on the portable electronic device to produce game play data; and computer program code for storing the game play data at the client device.

As a computer-implemented method for transferring game data from a portable electronic device where a software game is played to another electronic device, one embodiment of the invention includes at least the acts of: retrieving game play data from the portable electronic device, the software game having been previously operated on the portable electronic device to produce game play data; and transferring the game play data to the another electronic device over a wireless network.

As a computer readable medium including at least computer program code for transferring game data from a portable electronic device where a software game is played to another electronic device, one embodiment of the invention includes at least: computer program code for retrieving game play data from the portable electronic device, the software game having been previously operated on the portable electronic device to produce game play data; and computer program code for transferring the game play data to the another electronic device over a network.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a block diagram of a media purchase system according to one embodiment of the invention.

FIG. 1B is a block diagram of a media purchase system according to another embodiment of the invention.

FIG. 2 is a diagram of an exemplary graphical user interface that can be produced on a display (monitor) associated with a client device.

FIG. 3 is a flow diagram of a client game download process according to one embodiment of the invention.

FIG. 4 is a flow diagram of a synchronization and backup process according to one embodiment of the invention.

FIGS. 5A and 5B are flow diagrams of a client game version update process according to one embodiment of the invention.

FIG. 6 is flow diagram of media commerce processing according to one embodiment of the invention.

FIG. 7 is a flow diagram of media delivery processing according to one embodiment of the invention.

FIG. 8 shows an exemplary computer system suitable for use with the invention.

### DETAILED DESCRIPTION OF THE INVENTION

The invention pertains to a management application for managing game software. A game is considered one type of media. Hence, the management application can be referred to as a media management application. In one embodiment, the media management application can also manage other types of media besides games, such other media can include music, videos, images, audiobooks, ebooks, ring tones, and/or podcasts.

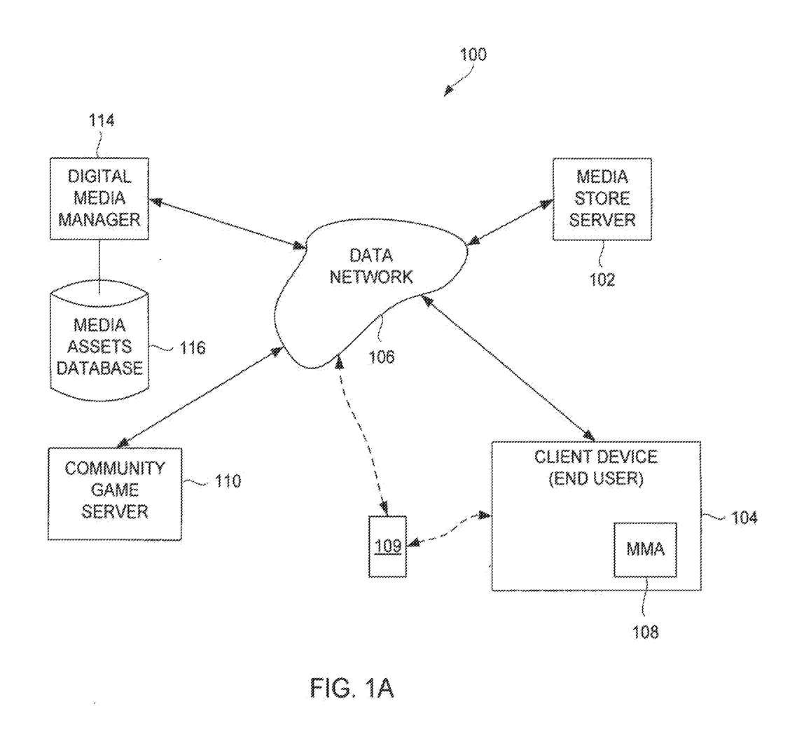

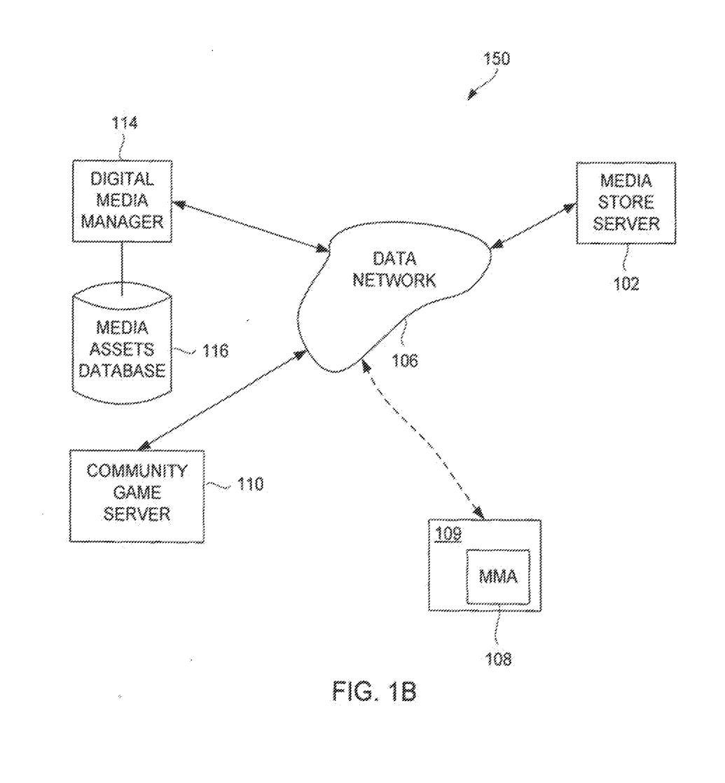

Embodiments of various aspects of the invention are discussed below with reference to FIGS. 1A-8. However, those skilled in the art will readily appreciate that the detailed description given herein with respect to these figures is for explanatory purposes as the invention extends beyond these limited embodiments.

One aspect of the invention pertains to acquiring compatible game software for a portable electronic device by way of an electronic download from a server device to a client device. Subsequently, the game software is provided from the client device to the portable electronic device. The acquisition of the game software can be through on-fine purchase or rental from the server device, which can host an on-line media store. Another aspect of the invention pertains to acquiring updates to game software that has previously been acquired and provided to a portable electronic device. Game software updates for a plurality of different hardware platforms are available from a server device. A client device associated with the portable electronic device can interact with the server device to obtain any game software updates that correspond to the hardware platform utilized by the portable electronic device associated with the client device. Still another aspect of the invention is that a client device can provide automated backup storage for game play data produced on an associated portable electronic device. Yet still another aspect of the invention is that game performance data associated with a user's performance of a game on a portable electronic device can be provided to a game server by way of a client device associated with the portable electronic device.

FIG. 1A is a block diagram of a media purchase system 100 according to one embodiment of the invention. The media purchase system 100 includes a media store server 102 that hosts an on-line media store. The media store server 102 can off-load commerce transactions and/or delivery of purchased digital media assets to other servers, if desired. As shown in FIG. 1A, the media purchase system 100 includes one or more client devices 104 for use by end users. The client devices 104 couple to a data network 106. Additionally, the media store server 102 also couples to the data network 106. In one implementation, the data network 106 can refer to one or more data networks, typically, high data-bandwidth networks, namely, wired networks, such as the Internet, Ethernet, gigabit Ethernet, and fiber optic, as well as wireless networks such as IEEE 802.11(a), (b) or (g) (WiFi), IEEE 802.16 (WiMax), and Ultra-Wide Band (UWB). The data network 106 can also include wireless networks such as Bluetooth or mobile telephony networks.

A computer program 108, typically a media management application (MMA) or other media player application, runs on the client device 104. One example of a media management application is the iTunes® application, produced by Apple Computer, Inc. of Cupertino, Calif. The client devices 104 are, in general, computing devices. As an example, the client devices 104 can be specific or general-purpose personal computers. In general, the computer program 108 can be used to manage media on the client device. More particularly, the computer program 108 can be used by a consumer for a variety of purposes, including, but not limited to: (i) browsing, searching and/or purchasing media assets from the on-line media store provided by the media store server 102, (ii) creating and sharing media asset groups (e.g., playlists), (iii) organizing media assets, (iv) presenting/playing media assets, and (v) transferring media assets to other devices.

The media purchase system 100 also includes a digital asset manager 114. The digital asset manager 114 is coupled to a media assets database 116. The media assets database 116 stores media asset information including metadata relating to digital media assets available for purchase (or rental) at the online media store. In one embodiment, the digital asset manager 114 controls what media assets and media asset information are available on the on-line media store. The metadata can pertain to individual media assets (digital media assets) or media asset groups (digital media asset groups). In one embodiment, media assets are games (i.e., executable game software). Media assets can also include, but are not limited to, audio (e.g., music, ring tones), video (e.g., movies), text, and/or graphics files.

The media store server 102 enables the user of a particular client device 104 to purchase media assets (e.g., games, songs, videos, albums) through on-line transactions. On-line transactions to purchase media items are also referred to as electronic commerce (e-commerce). Subsequently, the client device 104 can download the purchased media assets from the media store server 102, or some other server, via the data network 106. Once the purchased media assets are provided to the client device 104, the client device 104 can store the purchased media assets. At the client device 104, the purchased media assets can be managed as previously noted. The purchased media assets may or may not be playable on the client device 104.

A portable electronic device 109 can also be used with the media purchase system 100. The portable electronic device 109 is portable and typically used apart from the client device 104. However, the portable electronic device 109 can also connect to the client device 104. The portable electronic device 109 can connect to the client device 104 in a wireless or wired manner. As one example, the portable electronic device 109 can connect to the client device 104 over a wireless network (e.g., Bluetooth, infrared). As another example, the portable electronic device 109 can connect to the client device 104 via a cable (e.g., a USB or Firewire cable). As still another example, the portable electronic device 109 can connect to the client device 104 through a physical connection, such as by directly connecting an electrical connector on the portable electronic device 109 to a counterpart electrical connector on the client device 104. In one embodiment, the physical connection can be referred to as docking. The portable electronic device 109 can also directly connect to the data network 106 in a wireless manner.

Once the portable electronic device 109 is connected with the client device 104 by whatever means, purchased media assets can be copied or transferred from the client device 104 to the portable electronic device 109. The copying or transferring of the purchased media assets to the portable electronic device 109 can be done manually (e.g., on user request) or automatically (without user interaction). In one embodiment, the copying or transferring is performed automatically during a synchronization operation between the client device 104 and the portable media device 109. In one implementation, such synchronization can be automatically performed once the portable media device 109 connects with the client device 104. At the portable electronic device 109, the purchased media assets can be played. In other words, when a purchased media asset is game software, the game software can be executed on the portable electronic device 109, thereby enabling a user of the portable electronic device 109 to play the game. By interacting with the portable electronic device 109, the user can play the game. For example, the user can interact with the portable electronic device 109 through a user input device (e.g. keypad, dial, touch surface, etc.) or through voice commands.

As will be understood by those familiar with data networks, other network configurations are possible. Furthermore, while the media store server 102 and the digital asset manager 114 are shown as individual and separate devices, it will be understood by those familiar with the art that other configurations are possible. As one example, each device can be implemented such that it is distributed over multiple server computers. As another example, these various servers and/or managers can be implemented by a single physical server computer.

The media purchase system 100 illustrated in FIG. 1A can also be utilized to facilitate a community of game players. These game players acquire games via a client device and media management application, and then play the games on portable electronic devices. The game play data, including game performance data for specific games, can be transferred from the portable electronic devices to the client devices. The client devices can then transfer such game play data over the data network 106 to a game community server 110. For example, the game performance data can pertain to a high score that a user achieved while playing the game on a portable electronic device. In one embodiment, the game play data is secured, such as with a digital signature, so that the game data can be authenticated at the game community server 110. By sharing such game play data with the game community server 110, users are able to compete in contests, which may provide awards or prizes, and the like. In one embodiment, the portable electronic device 109 operates to save game play data, including game performance data, on the portable electronic device 109. During synchronization with the client device, or at other times, the game play data can be transferred from the portable electronic device 109 to the client device 104. Then, the client device 104 can, as appropriate, transfer the game play data to the game community server 110. The game play data can pertains to one or more of scores, times, performance, levels completed, favorite characters/competitors, user demographics (actual or virtual) (e.g., user name, screen name, avatars), etc.

In one embodiment, the portable electronic device 109 is a portable media player. One example of a portable media player suitable for use with the invention is the iPod®, also produced by Apple Computer, inc. The term “media player” generally refers to computing devices that process media such as audio, games, video or other images. In one implementation, the media player is a portable computing device. In another implementation, the media player is a portable communication device, such as a mobile telephone. These devices are generally portable so as to allow a user to listen to music, play games or video, record video or take pictures wherever the user travels. In one embodiment, the media player is a handheld device that is sized for placement into a pocket of the user (i.e., pocket-sized). By being pocket-sized, the user does not have to directly carry the device and therefore the device can be taken almost anywhere the user travels (e.g., the user is not limited by carrying a large, bulky and often heavy device, as in a portable computer). For example, in the case of a music player (e.g., MP3 player), a user may use the device while working out at the gym. Furthermore, the device may be operated by one or both the user's hands, no reference surface such as a desktop is needed.

Although the game software for games initially resides on a media store server or other server, such as a game server, the game software is electronically downloaded to client devices associated with users that have acquired (e.g., purchased, rented, etc.) the games. Thereafter, the game software can be copied from, the client devices to associated portable electronic devices. Once at the portable electronic devices, the game software can be executed so that users can play the games using their portable electronic devices.

Accordingly, in one embodiment, a management application operates on a client device and game software is acquired electronically from a server device. The game software is provided to a portable electronic device by way of the client device. The game software is operational on the portable electronic device.

In one embodiment, the electronic download of game software from the game server to a client device is performed using an electronic package. The electronic package includes the game software. The game software typically includes a plurality of game related files. At least one of the game related files is an executable file. To prevent unauthorized access, all or part of the electronic package or its contents can be encrypted. Further, one or more executable files of the game related files can be designed to execute on an authorized portable electronic device that has been associated with the client device. In this regard, the game software may only be usable on limited devices once downloaded. These limitations or restrictions can be used to prevent the unauthorized exchange of the game software. In addition, since the game software can be configured to execute on a particular portable electronic device, the contents of the electronic package can differ for different client devices.

Further, given that a user acquires game software for use on a particular portable electronic device, the game software being downloaded to the client device should be the appropriate game software for execution on the portable electronic device. Given that the games are designed to operate on a plurality of different portable electronic devices, the game server stores game software for a plurality of different portable electronic devices. In other words, the game software normally needs to be somewhat different for different portable electronic devices. For example, the portable electronic devices can be associated with different manufacturers and have different hardware characteristics. Alternatively, the portable electronic devices can pertain to different models or hardware platforms associated with the same manufacturer. Different models or hardware platforms can influence the game software, and thus different game software should be provided in such cases. For example, since at least one of the files of game software is an executable file (e.g., computer code) designed to execute on the portable electronic device, changes to the portable electronic device can affect the ability of the executable file to be properly executed.

When the portable electronic device is altered such as for bug fixes, firmware updates and the like, to the extent that such changes affect the ability of a previously acquired game to be played, game software updates for a given software game can be made available for different models or hardware platforms. Hence, a game software update can be made available to the users that previously acquired the game software so that the game software can be updated and thus continue to operate properly on the portable electronic device. For example, if a hardware component (e.g., processor, screen size, brightness, etc.) in a portable media device were to change, such could trigger the need for updated game software so that the game continues to operate properly on the portable electronic device.

In an alternative embodiment, a management application operates on a portable electronic device and game software is directly acquired electronically from a server device. The game software is operational on the portable electronic device.

FIG. 1B is a block diagram of a media purchase system 150 according to another embodiment of the invention. The media purchase system 150 is generally similar to the media purchase system 100 except that the portable electronic device 109 includes the media management application 108.

The media store server 102 enables the user of the portable media device 109 to purchase media assets through on-line transactions. The portable media device 109 can download the purchased media assets from the media store server 102, or some other server, via the data network 106. Once the purchased media assets are provided to the portable media device 104, the portable media device 104 can store the purchased media assets. At the portable media device 104, the purchased media assets can be managed. At the portable electronic device 109, the purchased media assets can be played. In other words, when a purchased media asset is game software, the game software can be executed on the portable electronic device 109, thereby enabling a user of the portable electronic device 109 to play the game. By interacting with the portable electronic device 109, the user can play the game. For example, the user can interact with the portable electronic device 109 through a user input device (e.g., keypad, dial, touch surface, etc.) or through voice commands. Like the media purchase system 100 illustrated in FIG. 1A, the media purchase system 150 can also be utilized to facilitate a community of game players. Games on portable electronic devices. The game play data, including game performance data for specific games, can be transferred from the portable electronic devices over the data network 106 to the game community server 110. Also, the game community server could also transfer data back to a portable electronic device. A user might specify the game related data of interest and such would be provided by the game community server. For example, a current high score maintained at the game community server can be automatically provided to the portable media device.

Although the above discussion concerning the game community server 100 pertains to game play data. Other types/class of data can be similarly acquired at the portable media device and subsequently transferred to another electronic device, such as a remote server (e.g., a community server). The remote server thus can provide storage and sharing of data amongst a community of users. In one embodiment, a distributed community of users can collaborate on related data by way of a community server. The users can send or receive data for collaboration, contents, etc. as discussed above. Such collaboration can deferred or delayed or non-real-time when users are not connected to a network. Examples of other types/class of data can include favorites (favorite books, songs, movies, etc.), media groups (e.g., playlists), annotations, commentaries, biographies, blogs, vblogs, audio blogs, etc. A user of a portable electronic device or client device can control the type/class or extent to which the data is shared. For example, a portable electronic device or client device can permit transfer to a remote server (and subsequent sharing) of certain data, while preventing transfer of other data. The transfer of the authorized data can, for example, be done automatically when the appropriate network connection is available. Also, the remote server can also operate to transfer data to the portable electronic device or the client device. For example, the remote server could transfer a current favorite song, ebook or other media, or a favorite amongst friends or some group of users.

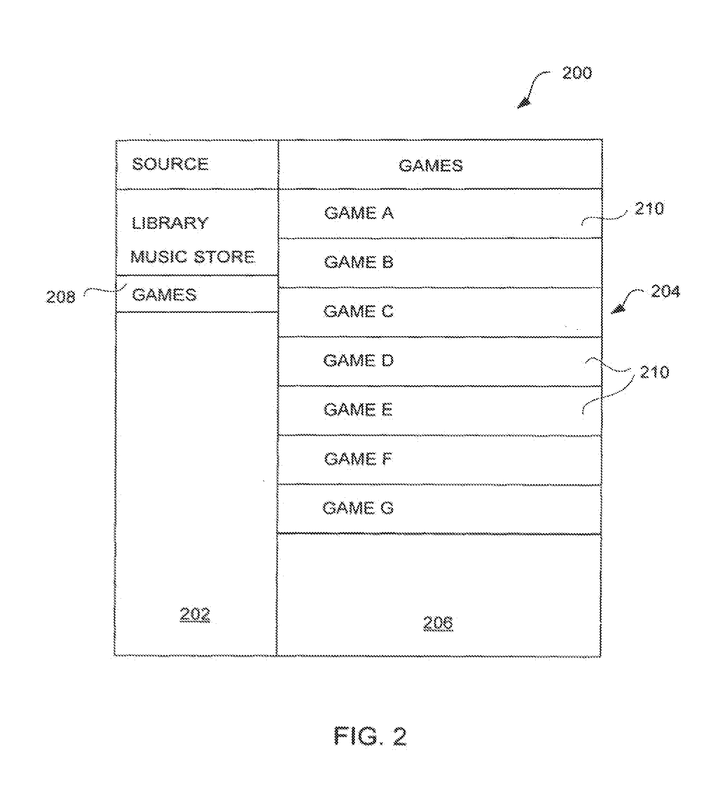

FIG. 2 is a diagram of an exemplary graphical user interface 200 that can be produced on a display (monitor) associated with a client device. The graphical user interface 200 is presented by the client device, namely, by a media management application operating on the client device, to allow a user of the client device to manage games or game operation, in one embodiment, the graphical user interface 200 is used to manage not only games but also other forms of media on the client device. The games, in one embodiment, operate on a portable media device associated with the client device.

The graphical user interface 200 includes a source region 202, a game listing region 204, and a game summary region 206. The source region 202 includes a plurality of different media sources that can be selected. In the example illustrated in FIG. 2, the source region 202 includes a “Library” media source, a “Music Store” media source, and a “Games” media source. In this example, the “Games” media source is shown being selected 208 (e.g., highlighted). When the “Games” media source is selected 208, the games listing region 204 displays a list of games. The list of games includes at least the names of games that are available on the client device. In the example illustrated in FIG. 2, the list of games illustrates a plurality of games 210 (i.e., Game A, Game B, Game C, Game D, Game E, Game F and Game G). Upon selection of one of the games 210 in the games listing region 204, the game summary region 206 can display at least one of (i) a summary for the selected game and (ii) instructions for playing the selected game.

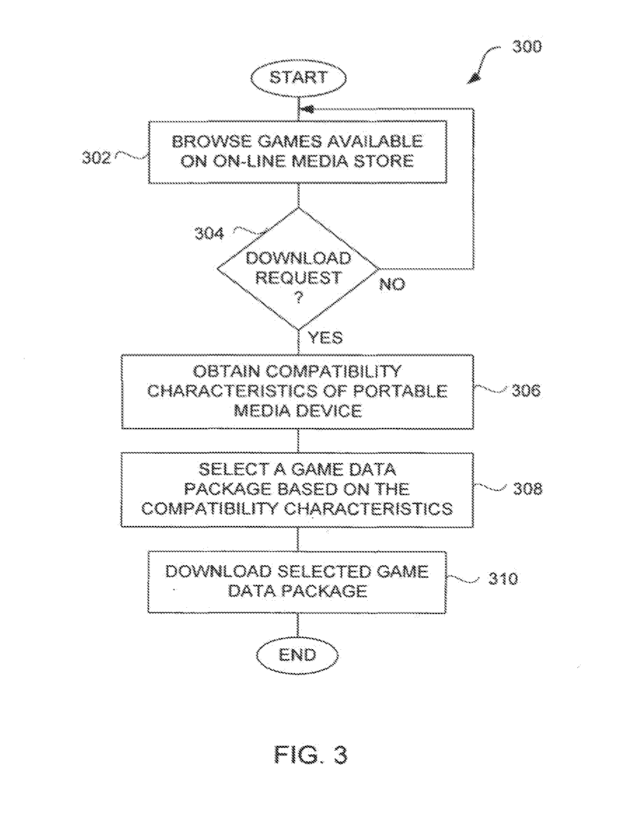

FIG. 3 is a flow diagram of a client game download process 300 according to one embodiment of the invention. The client game download process 300 is performed by a computing device, such as a client device. The client device can, for example, be the client device 104 illustrated in FIG. 1A. Typically, the client device performing the client game download process 300 is interacting with a server computer over a data network. For example, the server computer can pertain to an online media store 102, the digital media manager 114 or other media repository server. The server computer can also be referred to as a game server.

The client game download process 300 initially enables a user to browse 302 games available on an online media store. Typically, the online media store will host a plurality of games (i.e., multimedia games) that can be acquired by interested users through purchase, rental or other means. After the user has browsed 302 to a particular game that the user desires to acquire, the user can initiate a download request. Often, the download request is part of or follows a purchase or rental of the game. The user can initiate a download request by selection of a user interface control being presented on a display device associated with the client device. For example, the user interface control can be a soft button presented that on selection requests purchase or rental of an associated game and/or initiates a download request for the associated game.

In any case, a decision 304 determines whether a download request has been received. When the decision 304 determines that a download request has not been received, the client game download process 300 can return to repeat the block 302. On the other hand, when the decision 304 determines that a download request has been received, compatibility characteristics of the portable media device associated with the client device are obtained 306. As an example, the compatibility characteristics of the portal media device can pertain to a model and/or hardware. platform.

Next, a game data package can be selected 308 based on the compatibility characteristics. The selection 308 of the game data package can involve interaction with the server computer. The selected game data package can then be downloaded 310 to the client device. In one embodiment, the selected game package is downloaded 310 from the server computer to the client device. Following the block 310, the client game download process 300 ends. In one embodiment, the blocks 306-310 are performed automatically by the client device without any need for user assistance.

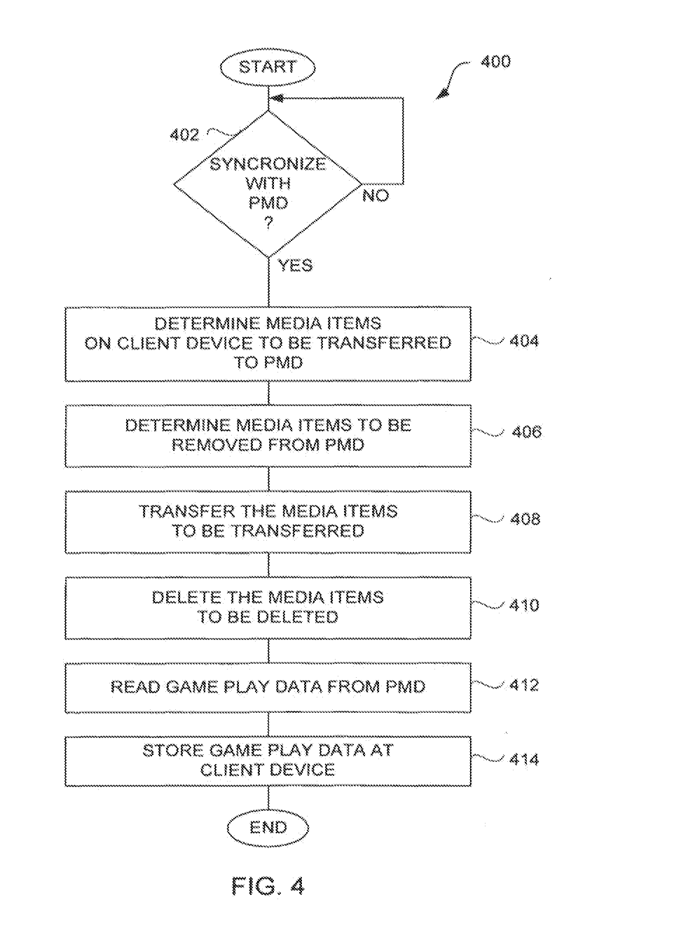

FIG. 4 is a flow diagram of a synchronization and backup process 400 according to one embodiment of the invention. The synchronization and backup process 400 is, for example, performed by a computing device, such as a client device. The client device can, for example, be the client device 104 illustrated in FIG. 1A. Typically, a media management application, such as the media management application 108 illustrated in FIG. 1A, would operate on the client device to perform the synchronization and backup process 400. During the synchronization and backup process 400, the client device interacts with a portable media device.

The synchronization and backup process 400 begins with a decision 402. The decision 402 determines whether the client device should be synchronized with an associated portable media device (PMD). When the decision 402 determines that synchronization with the portable media device is not to be performed at this time, the synchronization and backup process 400 waits until synchronization is to be performed. In general, synchronization is to be performed either on-demand such as following a user request, or automatically such as when the portable media device has just been coupled to the client device.

Alternatively, once the decision 402 determines that synchronization with the portable media device is to be performed, the synchronization and backup process 400 continues. In other words, the synchronization and backup process 400 can be deemed to be invoked whenever synchronization is to be performed, in any case, when the synchronization and backup process 400 continues, media items to be transferred from the client device to the portable media device are determined 404. Also, media items to be removed from the portable media device are determined 406. Further, the media items to be transferred to the portable media device are transferred 408. The media items that are to be deleted from the portable media device are also deleted 410.

In addition, game play data from the portable media device can be read 412 by the client device. As an example, the game play data can include data pertaining to game state, level or position. Optionally, the game play data can also include game performance data. The game play data can then be stored 414 at the client device. Following the block 414, the synchronization and backup process 400 ends.

Although the backup operations of blocks 412 and 414 are combined with the synchronization operations of blocks 404 through 410, it should be noted that the synchronization and backup operations can be separated into different processes. As result, synchronization and backup operations need not be performed at the same time. However, it can be convenient to perform these operations at the same time given that a data connection from the client device to the portable media device is needed in both cases.

It should also be noted that in the event that the portable media device loses its game play data, the game play data stored 414 at the client device can be utilized to restore the game play data to the portable media device. For example, the client device can restore the game play data to the portable media device that has lost its game play data. As another example, the client device can store the game play data to a new portable media device that is to be used with the client device.

In another embodiment, an alternative synchronization and backup process can be performed by a portable media device, such as the portable media device 109 illustrated in FIG. 1A or 1B. In one implementation, the alternative synchronization and backup process can be generally similar to the operation the synchronization and backup process 400 illustrated in FIG. 4. Here, with the alternative synchronization and backup process, the exchange of media items and/or game play data is from a remote server to the portable electronic device without need to utilize an intermediate client device. Thus, at block 404, for the alternative synchronization and backup process, the media item on the remote server would be determined, at block 412 the game play data would be read or transferred to the remote server, and at block 414 the game play data would be stored at the remote server. In general, alternative synchronization is to be performed either on-demand such as following a user request, or automatically such as periodically when the network connection is available to the portable media device.

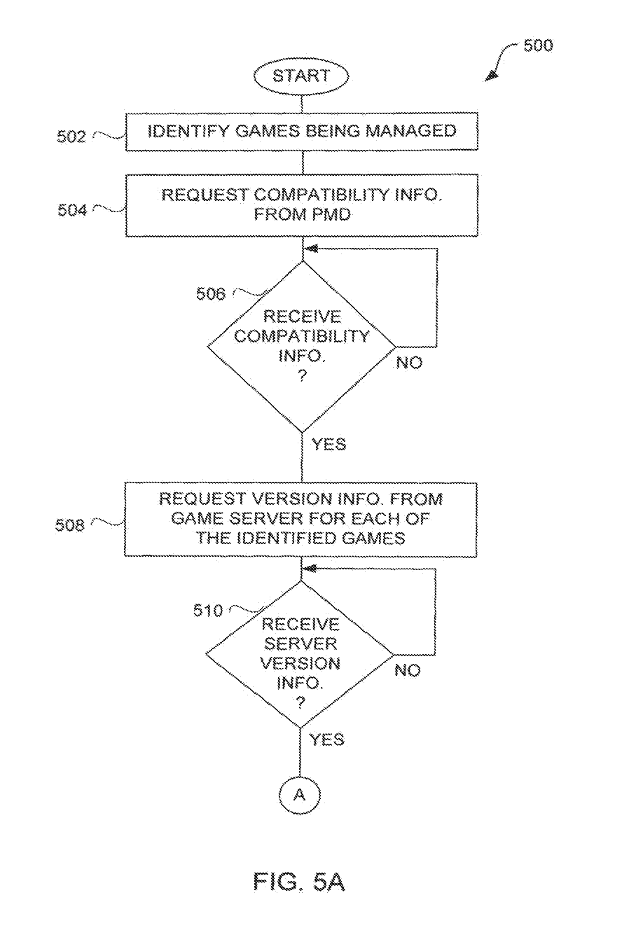

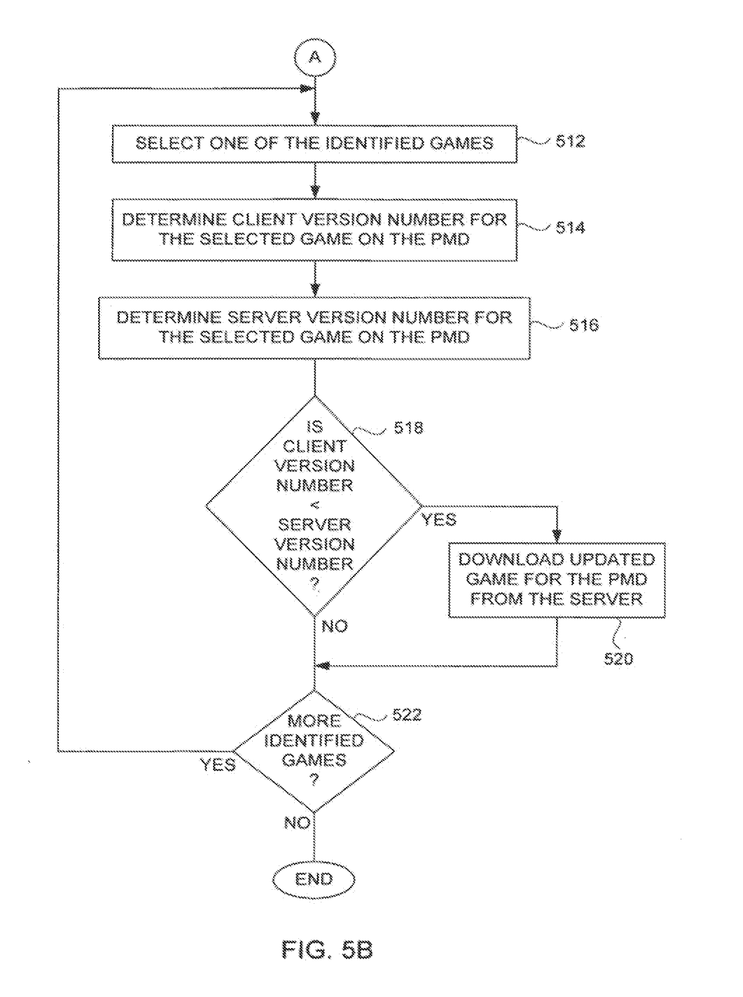

FIGS. 5A and 5B are flow diagrams of a client game version update process 500 according to one embodiment of the invention. The game version update process 500 is, for example, performed by a computing device, such as a client device. The client device can, for example, be the client device 104 illustrated in FIG. 1A. Typically, a media management application, such as the media management application 108 illustrated in FIG. 1A, would operate on the client device to perform the client game version update process 500.

The client game version update process 500 initially identifies 502 games being managed. Typically, the games being managed are managed by the media management application. Next, the client device requests 504 compatibility information from the portable media device. The compatibility information can, for example, include model and/or hardware platform information of the portable media device. A decision 506 then determines whether the compatibility information has been received. When the decision 506 determines that the compatibility information has not been received, the client game version update process 500 awaits such information.

On the other hand, when the decision 506 determines that the compatibility information has been received, version information from the game server for each of the identified games is requested 508. Here, the game server is a server device that stores games that can be acquired and downloaded to client devices. In one embodiment, the games do not execute on the client device, but instead are transferred to the portable media device where the games are executable. In another embodiment, the games are executable on not only the portable media device but also the client device, in any case, after the version information has been requested 508 from the game server, a decision 510 determines whether server version information has been received. When the decision 510 determines that the server version information has not yet been received, the client game version update process 500 awaits such version information.

Alternatively, when the decision 510 determines that the server version information has been received, then further processing is performed so that the appropriate game updates can be retrieved from the game server and supplied to the client device. In this regard, one of the identified games is initially selected 512. Then a client version number for the selected game on the portable electronic device is determined 514. The client version number is the particular version of the selected game at the client device for the model and/or hardware platform associated with the portable media device. Also, a server version number for the selected game on the portable electronic device is determined 516. The server version number is the most recent version of the selected game at the game server for the model and/or hardware platform associated with the portable media device.

Next, a decision 518 determines whether the client version number is less than the server version number. When the decision 518 determines that the client version number is less than the server version number, an updated game for the portable electronic device is downloaded 520 from the game server. The game server is the server that stores the executable computer code and related files (i.e., game data or game package) that are utilized to operate a game. Following the block 520, as well as following the decision 518 when the client version number is not less than the server version number, a decision 522 determines whether there are more identified games to be processed. When the decision 522 determines that there are more identified games to be processed, the client game version update process 500 returns to repeat the block 512 and subsequent blocks. Accordingly, blocks 512 through 520 can be performed in a similar manner for each of the identified games that are being managed by the client device. Once the decision 522 determines that all of the identified games have been processed, the client game version update process 500 ends.

Another aspect of the invention pertains to delivery of game data from a game server to a client device. In one embodiment, the game server provides game software to the client device as a package of files (i.e., game data package or game package). One of the files in the package is a manifest file which provides a list of files within the package. In one embodiment, the package of files can include a plurality of different executable versions. The different executable versions can be for use on different models and/or hardware platforms. In such case, the client device can choose the appropriate version of game data to be delivered to the portable media device. One or more other of the files in the package can be executable files that execute on the client device. For security reasons, some or all of the files in the package can include a hash value. The hash value can be utilized to ensure that the associated files not been tampered with. The manifest itself can be secured by a cryptographic signature. Security violations can be detected when a given file in the manifest file is not at the correct location in the package and/or the hash value associated with a particular file does not match a corresponding hash number contained in an archive file.

According to one embodiment, an electronic package or game data package can be referred to as an application bundle. In one example, the application bundle can be provided at a root directory and contain a manifest file for the application as well as directories for executable(s) and resources.

A manifest file, e.g., “/Manifest.plist”, is a Core Foundation property list file containing a dictionary of key/value pairs, representing the supported platforms and required files for the application, in one embodiment, the manifest file is a markup language file, such as an XML file.

As an example, the manifest file can utilize one or more of the following keys:
GUID—A 64-bit value, expressed as a hexadecimal string, representing a globally unique identifier for the application. The value can be created using the uuidgen command-line tool (/usr/bin/uuidgen) and taking the last 64 bits (16 hex characters) of the generated 128-bit UUID.
Name—The default name of the application. Can be overridden by the localized info.plist.
Version—The user-visible version number for the application to be displayed by the media management application.
Platforms—An array of dictionaries specifying the supported platforms for the application. Each dictionary contains the following keys:
   PlatformID—The identifier for the device platform, expressed as an integer. A platform identifier corresponds to a user-identifiable electronic device model. For example, the electronic device can be an iPod® media device.
   PlatformVersion—The identifier for the platform compatibility version, expressed as an integer. Each platform version represents a different configuration of the base platform, such as a different screen LCD, which may require separate executables for the application. The platform version identifiers can be scoped within a platform identifier, so the same platform version identifier can be used for different platform identifiers.
   BuildID—The identifier for the build for this platform identifier and version, expressed as an integer. The build identifier is incremented for each released build of the executable for the platform. The build identifier can be used with a web-based version update mechanism to determine if an update is available for the application.
   ExecutablePath—The path to the executable for this platform and variant, relative to the root of the bundle. The same executable can be used for more than one platform and variant, if desired and appropriate.
   Files—An array of dictionaries specifying the required files for the application. Any files that are specified in the array must be present in order for the application to be launched. Each dictionary contains the following keys:
      Path—The path to the file, relative to the root of the bundle,
      Size—The size of the file, in bytes. Needed only if the Digest key is present. If present, the electronic device will verify that the size of the file matches the specified size.
      Digest—The SHA-1 digest of the contents of the file, expressed as a 40-digit hexadecimal string. Recommended because it allows the media management application to verify the integrity of all the files in the bundle,
      verify—A Boolean flag indicating if the digest for the file must be verified by the electronic device. The default is false. if true, the electronic device will verify that the SHA-1 digest of the contents of the file matches the specified digest,
      DRM—A Boolean flag indicating if the file is to be DRM-protected. The default is false, if specified as true, the media management application will expect to receive security information (i.e., the contents of the .sinf file(s)) for the bundle as part of the download process from the media store.

Another file within the application bundle, e.g., “/Manifest.plist.p7b” can be a DER-encoded PKCS #7 file containing a signed-data content type with the digital signature for the Manifest.plist file and the certificate chain used to generate the signature. Both the media management application and the electronic device will verify the digital signature and only display the application bundle and/or allow it to be run if both the certificate chain and the signature itself are valid.

A resources directory (e.g., “/Resources/”) contains non-localized resources used by the application, such as artwork image files. A locale resources directory (e.g., “/Resources/<locale>/”). contains one or more directories for localized resources for each supported locale. In one implementation, <locale> is a standard ISO 3166 language and region code pair, separated by an underscore (“_”): e.g., en_US, fr_FR, ja_JP, etc.

Another Core Foundation property list file (e.g., “/Resources/<locale>/Info.plist”) contains a dictionary of key/value pairs, representing the localized user-visible information to be displayed by media management application. The following keys can be utilized:
Name—The localized name of the application, if not specified, defaults to the application name specified in the manifest.
   An example Info.plist file is as follows:

```
<?xml version=“1.0” encoding=“UTF-8”?>
<!DOCTYPE plist PUBLIC “-//Apple Computer//DTD PLIST 1.0//EN”
“http://www.apple.com/DTDs/PropertyList-1.0.dtd”>
<plist version=“1.0”>
<dict>
    <key>Name</key>
    <string>SimpleSample</string>
</dict>
</plist>
```

Alternatively, instead of Info.plist file containing the localized information, the manifest file can include an additional key:
LocalizedNames—A dictionary containing the localized names of the application. For each element in the dictionary, the key can be the standard ISO 3166 language and region code pair, separated by an underscore (“_”), and the value can be the localized name of the application, expressed as a string. Optional; defaults to the name specified by the value of the Name key.

The application bundle can also include a descriptive file (e.g., “/Resource/<locale>/Desrciption.xml”) of the application to be displayed by media management application, specified using a markup language such as an XML markup language (e.g., the iTunes Music Store XML markup language). The XML markup may contain references to PNG or JPEG image files contained within the application bundle, expressed as either relative URLs (such as ../Images/Artwork. png) or absolute URLs (such as /Resources/Images/Artwork.png).

Still further the application bundle car include one or more separate directories (e.g. “/Executables/<PlatformID>/”) used for each platform, wherein the directories contain the executable file for a specific platform can be specified. Alternatively, all the executables could be put in a single directory.

An example of an exemplary manifest file (Manifest.plist) is provided below

```
<?xml version=“1.0” encoding=“UTF-8”?>
<!DOCTYPE plist PUBLIC “-//Apple Computer//DTD PLIST 1.0//EN”
“http://www.apple.com/DTDs/PropertyList-1.0.dtd”>
<plist version=“1.0”>
<dict>
    <key>Files</key>
    <array>
        <dict>
            <key>DRM</key>
            <true/>
            <key>Digest</key>
    <string>FF84B2D79F6C44DAFA09D71AF2C1556AD0128D04
    </string>
            <key>Path</key>
            <string>Executables/2/SimpleSample</string>
            <key>Size</key>
            <integer>1397044</integer>
            <key>Verify</key>
            <true/>
        </dict>
        <dict>
            <key>Digest</key>
    <string>5B4A10B81AFA5CECB321F40FB6AE882194B57617
    </string>
            <key>Path</key>
            <string>Resources/en_US/Info.plist</string>
            <key>Size</key>
            <integer>424</integer>
        </dict>
        <dict>
            <key>Path</key>
            <string>Resources/fr_FR/Info.plist</string>
            <key>Size</key>
            <integer>428</integer>
        </dict>
        <dict>
            <key>DRM</key>
            <true/>
            <key>Digest</key>
    <string>E9495BC8DF7248E7EE597F00C771EE192B4A1FCD
    </string>
            <key>Path</key>
            <string>Resources/Artwork.png</string>
            <key>Size</key>
            <integer>136864</integer>
            <key>Verify</key>
            <false/>
        </dict>
    </array>
    <key>GUID</key>
    <string>BFA9E26497A439E1</string>
    <key>Name</key>
    <string>SimpleSample</string>
    <key>Platforms</key>
    <array>
        <dict>
            <key>BuildID</key>
            <integer>12</integer>
            <key>ExecutablePath</key>
            <string>Executables/2/SimpleSample</string>
            <key>PlatformID</key>
            <integer>2</integer>
            <key>PlatformVersion</key>
            <integer>1</integer>
        </dict>
        <dict>
            <key>BuildID</key>
            <integer>12</integer>
            <key>ExecutablePath</key>
            <string>Executables/2/SimpleSample</string>
            <key>PlatformID</key>
            <integer>2</integer>
            <key>PlatformVersion</key>
            <integer>2</integer>
        </dict>
        <dict>
            <key>BuildID</key>
            <integer>12</integer>
            <key>ExecutablePath</key>
            <string>Executables/2/SimpleSample</string>
            <key>PlatformID</key>
            <integer>2</integer>
            <key>PlatformVersion</key>
            <integer>3</integer>
        </dict>
    </array>
    <key>Version</key>
    <string>1.0</string>
</dict>
</plist>
```

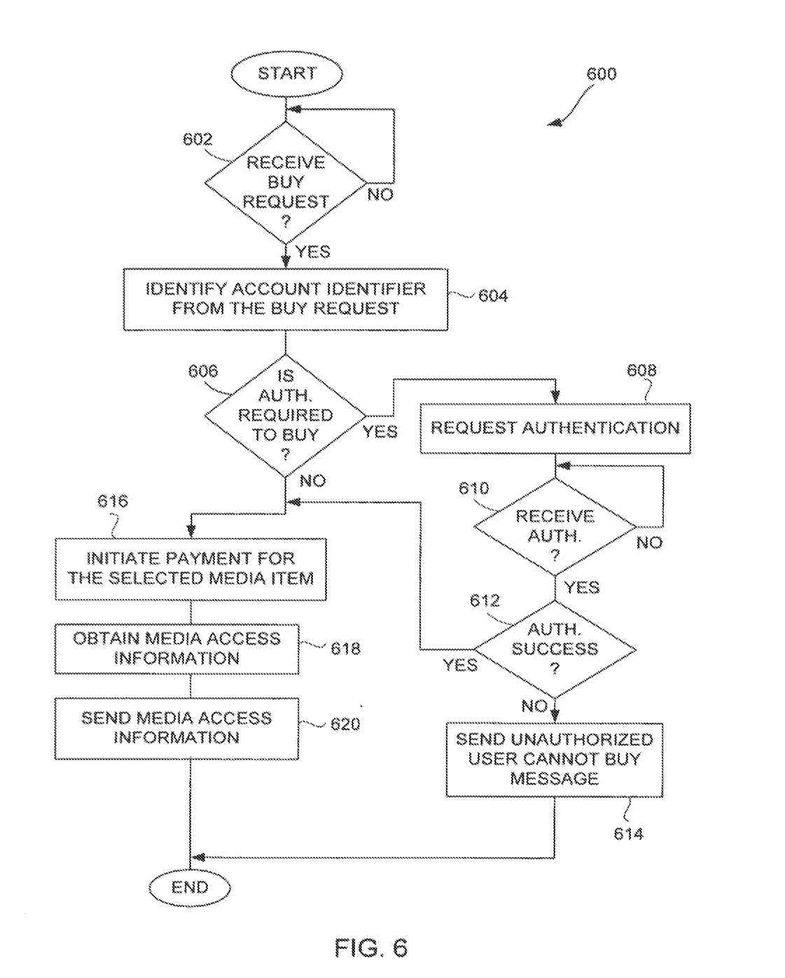

FIG. 6 is flow diagram of media commerce processing 600 according to one embodiment of the invention. The media commerce processing 600 is, for example, performed by a media store server, such as the media store server 102 illustrated in FIG. 1A, which can not only provide an on-line media store but also a media commerce server. Alternatively, the media commerce processing 600 could be performed by a dedicated media commerce server.

The media commerce processing 600 begins with a decision 602 that determines whether a buy request has been received. When the decision 602 determines that a buy request has not yet been received, the media commerce processing 600 awaits such a request. A buy request can be as a result of a real-time purchase of a digital media asset from an on-line media store or as the result of a deferred purchase (e.g., due to a pre-order) of a digital media asset from the on-line media store. On the other hand, once the decision 602 determines that a buy request has been received, the media commerce processing 600 proceeds to process the buy request. In this regard, an account identifier is identified 604 from the buy request. Here, the buy request is sent by a client device to the media commerce server on behalf of a user of the client device (namely, a user of a media player application operating on the client device). in one embodiment, the buy request that is sent to the media commerce server includes not only an account identifier for the user of the client but also at least one media item identifier, media price, and a password token. The password token is a random value (e.g., 128 bit string) that is different for every user. The media storage server provides the password token to the client as a result of successful authentication of the user. When the buy request includes a valid password token, the media commerce server can deem the client as properly authenticated.

Next, a decision 606 determines whether authentication is required prior to purchase of the media items. When the decision 606 determines that authentication is required, additional processing can be performed to determine whether such authentication exists. In one embodiment, the user's account or client can configure whether such authentication is required or can be overridden by the user, in one embodiment, the authentication is provided to help protect the user of the client device (e.g., media player) from other unauthorized users who might access the media commerce server from the client device after the user has successfully been authenticated to the media commerce server. The re-authentication is thus used to confirm that the particular user of the client device (e.g., media player) is indeed the authorized user for such a system. In this regard, authentication is requested 608. Then, a decision 610 determines whether an authentication response has been received. Once the decision 610 receives the authentication response, a decision 612 determines whether the authentication response is able to successfully authenticate the user. When the decision 612 determines that authentication has not been successful, a message indicating that an unauthorized user cannot buy media items is sent 614 to the client for display to the user.

On the other hand, when the decision 612 determines that authentication has been successful, then additional processing is performed to facilitate the purchase of the selected media item identified in the buy request. In this regard, payment for the selected media item is initiated 616. Here, according to one embodiment, the payment can be made by a credit card, and the initiation of such payment can verify the credit card's existence, but may or may not seek to post the charge at this time. It may be more efficient and desirable to defer the actual posting of the credit to the credit card until a later time. Nevertheless, after the payment for the selected media item has been initiated 616, media access information is obtained 618. The media access information is information that will enable the client (e.g., media management application) to retrieve and then access the media content for the selected media item. The media access information, in one embodiment, includes a URL, a download key, and a security token. Next, the media access information is sent 620. Here, the media access information is sent from the media commerce server to the client device, namely, the media management application operating on the client device. At this point, the transaction is not fully completed because the media content for the selected media item has not yet been received by the client device. Following the operations 614 and 622, the media commerce processing 600 is complete and ends.

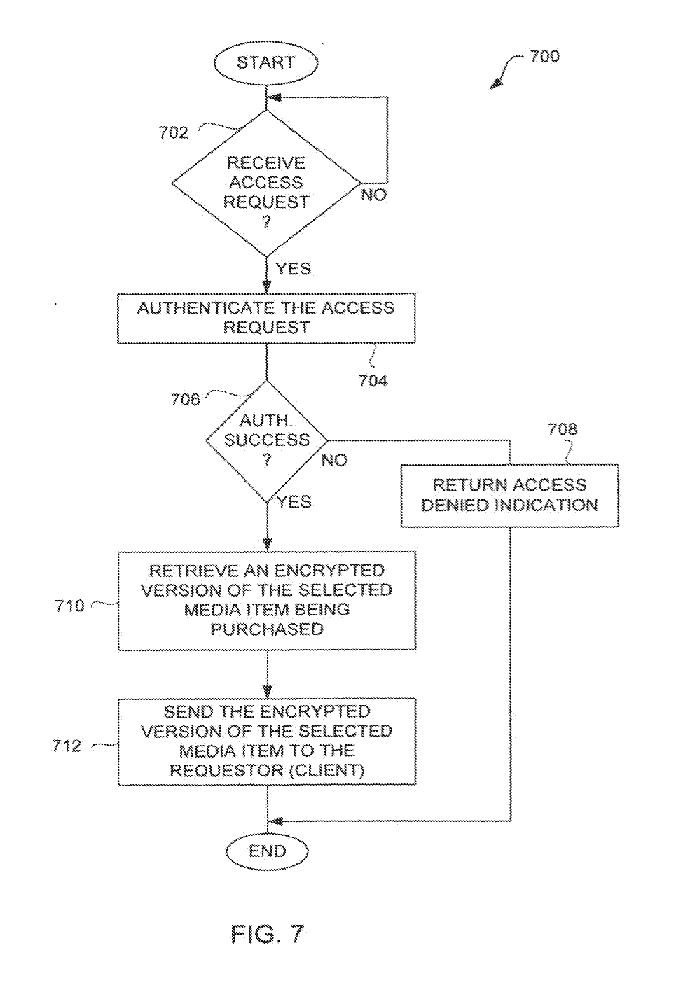

FIG. 7 is a flow diagram of media delivery processing 700 according to one embodiment of the invention. The media delivery processing 700 is, for example, performed by the media store server 102 illustrated in FIG. 1A, which can not only provide an on-line media store but also a media storage server that stores and manages delivery of digital media assets. Alternatively, the media delivery processing 700 can be performed by a dedicated media storage server.

The media delivery processing 700 begins with a decision 702. The decision 702 determines whether an access request has been received. An access request is a request from a client device to obtain the media content for one or more media items that are stored in a media store associated with the media storage server. In one embodiment, the access request includes at least a URL for the selected media item and a security token from the client device. When the decision 702 determines that an access request has been received, then the media delivery processing 700 is effectively invoked. In other words, once an access request has been received, the access request is authenticated 704. The authentication 704 involves the analysis of at least a portion of the access request to authenticate that the request is legitimate and from one that was authorized by the media commerce server. In one embodiment, a hash algorithm can be applied to the URL, a name of the media commerce server, and a time of purchase. The result of the hash algorithm is then compared with the security token, which is the product of a complimentary hash algorithm performed at the media commerce server. A decision 706 then determines whether the authentication was successful. Here, in one embodiment, if the hashing algorithm approach is used, the result of the hash algorithm should match the security token within some tolerance set by a time limitation. For example, the tolerance due to time might permit the access request to remain authenticated for forty-eight (48) hours after purchase.

When the decision 706 determines that the authentication was not successful, then an access denied indication is returned 708. Here, the access request is denied and the client device is so notified. On the other hand, when the decision 706 determines that the authentication was successful, then an encrypted version of the selected media item that has been purchased is retrieved 710. Here, the media storage server would retrieve the encrypted version of the selected media item from a media storage device. Then, the encrypted version of the selected media item is sent 712 to the client device (requestor). In other words, the encrypted version of the selected media item is downloaded to the client device that has requested the selected media item. Following the operations 708 and 712, the media delivery processing 700 is complete and ends.

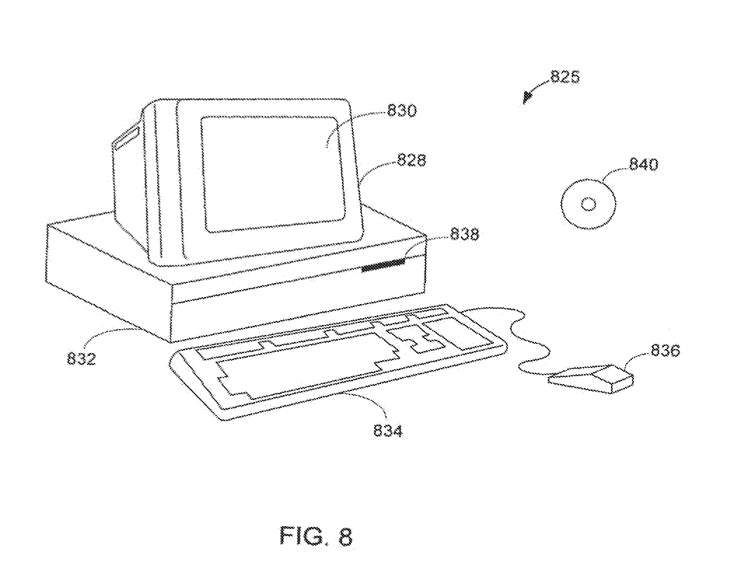

FIG. 8 shows an exemplary computer system 825 suitable for use with the invention. Computer system 825 includes a display monitor 828 having a single or multi-screen display 830 (or multiple displays), cabinet 832, keyboard 834, and mouse 836. Cabinet 832 houses a drive 838, such as a CD-ROM or floppy drive, system memory and a hard drive (not shown) which may be utilized to store and retrieve software programs incorporating computer code that implements some or all aspects of the invention, data for use with the invention, and the like. Although CD-ROM 840 is shown as an exemplary, computer readable storage medium, other computer readable storage media including floppy disk, tape, flash memory, system memory, and hard drive may be utilized. Additionally, a data signal embodied in a carrier wave (e.g., in a network) may be the computer readable storage medium. In one implementation, a software program for the computer system 825 is provided in the system memory, the hard drive, the CD-ROM 840 or other computer readable storage medium and serves to incorporate the computer code that implements some or all aspects of the invention.

The digital media assets (i.e., digital media items) can pertain: to audio items (e.g., audio files or audio tracks, such as for songs (music) or audiobooks), video items (e.g. video files or movies), image items (e.g., photos), or game items (e.g., game software).

The various aspects, features, embodiments or implementations of the invention described above can be used alone or in various combinations.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1-19. (canceled)

20. A method for handling media assets, comprising: in a portable media device,
managing media assets that are stored on the portable media device, the managing comprising:
acquiring compatibility information for the portable media device;
using the compatibility information to determine when one or more of the media assets that are stored on the portable media device are incompatible with the portable media device; and
downloading an updated version of the one or more media assets that are stored on the portable media device from a server device, the updated version of the one or more media assets being compatible with the portable media device.

21. The method of claim 20, wherein using the compatibility information to determine when one or more of the media assets that are stored on the portable media device are incompatible with the portable media device comprises:
in the portable media device, for each of the one or more media assets that are stored on the portable media device:
requesting version information for the media asset from the server device;
based on the compatibility information, determining a current version of the media asset from the version information; and
determining that the media asset is incompatible with the portable media device when a comparison of the current version with a version acquired from the media asset indicates that the server device has an updated version of the media asset.

22. The method of claim 21, wherein the compatibility information comprises a model of the portable media device and a hardware platform of the portable media device.

23. The method of claim 20, wherein the media asset is a game that is configured to be played on the portable media device.

24. The method of claim 20, wherein the media asset is an application that is configured to be executed on the portable media device.

25. The method of claim 20, further comprising:
acquiring information associated with the media asset; and
uploading the information associated with the media asset to the server device.

26. The method of claim 25, wherein the media asset is a game that is configured to be played on the portable media device and wherein the information associated with the game is in-game data generated while playing the game on the portable media device.

27. The method of claim 20, further comprising: in the portable media device,
receiving a command to purchase and download a media asset from the server device, the portable media device being coupled to a network to which the server device is coupled; and
purchasing and downloading the media asset from the server device.

28. The method of claim 27, wherein downloading the media asset from the server device comprises:
in the portable media device,
acquiring compatibility information for the portable media device; and
downloading media asset data package with a version of the media asset that is compatible with the portable media device.

29. The method of claim 27, wherein receiving the command comprises:
receiving a voice command in the portable media device.

30. An apparatus that handles media assets, comprising:
a portable media device configured to manage media assets that are stored on the portable media device, the managing comprising:
acquiring compatibility information for the portable media device;
using the compatibility information to determine when one or more of the media assets that are stored on the portable media device are incompatible with the portable media device; and
downloading an updated version of the one or more media assets that are stored on the portable media device from a server device, the updated version of the one or more media assets being compatible with the portable media device.

31. The apparatus of claim 30, wherein, when using the compatibility information to determine when one or more of the media assets that are stored on the portable media device are incompatible with the portable media device, the portable media device is configured to:
for each of the one or more media assets that are stored on the portable media device:
request version information for the media asset from the server device;
based on the compatibility information, determine a current version of the media asset from the version information; and
determine that the media asset is incompatible with the portable media device when a comparison of the current version with a version acquired from the media asset indicates that the server device has an updated version of the media asset.

32. The apparatus of claim 31, wherein the compatibility information comprises a model of the portable media device and a hardware platform of the portable media device.

33. The apparatus of claim 30, wherein the media asset is a game that is configured to be played on the portable media device.

34. The apparatus of claim 30, wherein the media asset is an application that is configured to be executed on the portable media device.

35. The apparatus of claim 30, wherein the portable media device is further configured to:
acquire information associated with the media asset; and
upload the information associated with the media asset to the server device.

36. The apparatus of claim 35, wherein the media asset is a game that is configured to be played on the portable media device and wherein the information associated with the game is in-game data generated while playing the game on the portable media device.

37. The apparatus of claim 30, wherein the portable media device is further configured to:
receive a command to purchase and download a media asset from the server device, the portable media device being coupled to a network to which the server device is coupled; and
purchase and download the media asset from the server device.

38. The apparatus of claim 37, wherein, when downloading the media asset from the server device, wherein the portable media device is configured to:
acquire compatibility information for the portable media device; and
download media asset data package with a version of the media asset that is compatible with the portable media device.

39. The apparatus of claim 37, wherein, when receiving the command, the portable media device is configured to:
receive a voice command.
